(19) United States
(12) Patent Application Publication
(10) Pub. No.: US 2017/0358014 A1
(43) Pub. Date: Dec. 14, 2017

(54) Card-Linked Fundraising

(71) Applicant: Christopher J. Jensen, Denver, CO (US)

(72) Inventor: Christopher J. Jensen, Denver, CO (US)

(73) Assignee: Christopher Jensen, Denver, CO (US)

(21) Appl. No.: 15/176,657

(22) Filed: Jun. 8, 2016

(51) Int. Cl. G06Q 30/02; G06Q 20/02; G06Q 20/22

(52) U.S. Cl. CPC G06Q 30/0279; G06Q 20/22; G06Q 20/02

(57) ABSTRACT

Card-linked fundraising is disclosed. Purchase information and a customer identifier are received at a fundraising platform. The purchase information is associated with a transaction between a merchant and a customer associated with the customer identifier. A cause associated with the customer identifier is determined. The customer identifier was previously registered with the cause at the platform. A donation is determined based at least in part on the purchase information. Payment of the donation to the cause is facilitated at the platform.

### BACKGROUND

Fundraising tied to consumer spend is a growing form of charitable giving. Many of the existing approaches of consumer spend-associated fundraising rely on prepaid or gift cards. An example is scrip-based fundraising, in which prepaid scrip organizations sell prepaid merchant cards (e.g., gift cards) to nonprofits and schools at a discount; the Causes then resell those cards at full prices, keeping the net profit. This procedure does not directly leverage credit or debit cards for fundraising, and may be inefficient for the Customer, Cause, and Merchant.

Other existing approaches require a change to the Merchant's Point of Sale (POS) system to track spend, which can be cumbersome for the Merchant. In other typical approaches, Customers may be required to present a specific payment device, loyalty card or coupon at the register at time of payment in order to track their spend, while some focus on online sales (vs. brick-and-mortar, where >90% of commerce takes place in the US at present), and require the Customer to use a unique hyperlink to track their purchase. Fundraising techniques that are efficient for the Consumer, Cause, and/or Merchant would be beneficial.

### BRIEF DESCRIPTION OF THE DRAWINGS

Various embodiments of the invention are disclosed in the following detailed description and the accompanying drawings.

FIG. 1 presents an illustration of an existing method, which involves gift cards for fundraising.

FIG. 2 is an example display illustrating embodiments of interface where a Customer can see and/or edit which Cause they are contributing to, how much they have raised on behalf of a Cause, and the payment device(s) they have registered.

FIG. 3 illustrates a display showing a list of participating Causes to which the Customer can direct the Donations tied to his or her spend.

FIG. 4 shows a detail screen for one of the Merchants that participate on the Platform.

FIG. 5 shows a detail screen for one of the Causes that participate on the Platform.

FIG. 6 illustrates a list of Merchants who participate in the program.

FIG. 7 shows an example of a mapping feature whereby the Customer may locate Merchants or Causes in proximity to their own location.

FIG. 8 shows an example of a notification that a Customer may receive upon transacting with a participating Merchant.

FIG. 9 illustrates a display (e.g. page) where a Customer can see and track the history of Donations tied to their spend at participating Merchants.

FIG. 10 describes one embodiment for fundraising through card-linked shopping.

FIG. 11 describes one embodiment for fundraising through item-level or SKU-level purchases.

FIG. 12 is a flow chart describing an embodiment of the Platform payment flow (see Claims section for alternative embodiments):

FIG. 13 describes an embodiment of the flow of data in the Platform process.

The illustrative aspects are described more fully by the Figures and detailed description. The present disclosure may, however, be embodied in various forms and is not limited to specific aspects described in the Figures and detailed description.

### SUMMARY

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles and aspects of the disclosure, as well as specific examples thereof, are intended to encompass both structural and functional equivalents thereof. Additionally, it is intended that such equivalents include both currently known equivalents as well as equivalents developed in the future, e.g., any elements developed that perform the same function, regardless of structure.

Thus, for example, it will be appreciated by those skilled in the art that any block diagrams herein represent conceptual views of illustrative circuitry embodying the principles of the disclosure. Similarly, it will be appreciated that any flow charts, flow diagrams, state transition diagrams, and the like represent various processes which may be substantially represented in computer readable medium and so executed by a computer or processor, whether or not such computer or processor is explicitly shown.

The functions of the various elements shown in the Figures, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

Unless otherwise explicitly specified herein, the drawings are not drawn to scale.

Fundraising through card-linked and receipt-verified shopping is disclosed. By tying fundraising to shopping incentives, this method allows Customers to raise money for their favorite Causes through their shopping, dining, or other consumer activities. This method identifies qualifying transactions through a Customer's existing credit, debit, and/or mobile payment devices, or through validation of the Customer's receipt after the transaction, which may then trigger a donation to the Customer's Cause of choice. Customers may interact with the method through their mobile device, tablet, computer or other electronic system, and may select their preferred Cause to which they want donations directed, vs. other methods that allow the Merchant to select the beneficiary.

The techniques disclosed herein provide an easy and attractive way to fundraise for customers, especially compared with other common fundraisers which ask supporters to go out of pocket for their donations or to purchase goods they may not want (e.g., chocolate, wrapping paper, magazine subscriptions, etc.). It also provides a simpler method for fundraising for the Cause by eliminating the logistical burden of existing methods, so they can spend more of their time and money on core operations. Further, this approach provides an effective way to reach Customers for both Merchants and Causes (and in particular for the Merchants, since they are often the ones who fund or pay for the Donation in the Platform).

In various embodiments, Customers are not required to carry and present a separate card at time of purchase—instead they 1) register an existing credit or debit card and present that as they normally would at the register, or 2) submit an image of their transaction receipt as proof of purchase. In scenario 1, the transaction is tracked through integration with the payment stream, most often upstream from the POS, including at the payment network or payment processor level, while in scenario 2 it is tracked through validation of the receipt by a human or computer scan system.

Customers may be able to track their behavior and the funds raised through that behavior within the system's interface. This may include a summary of funds raised in total, for each Cause and by each Merchant, and may be specific for each Customer and/or for the Platform as a whole.

Customers may be able to raise money for one cause in some cases, and in other cases they may be able to raise money for several causes in this method.

This techniques disclosed herein provide tools to Causes to help increase Customer engagement and funds raised through the Platform. For example, the method may include some form of “gamification,” whereby Customers are encouraged to compete with one another on the Platform for points, status, or other benefits.

This approach provides an attractive marketing platform for Merchants and consumer goods companies (CPGs). First, this approach allows Merchants to drive sales without discounting products to the Customer, as the incentive is instead in the form of a contribution to the Customer's Cause. As discounting can erode brand value and train Customers to shop only when they get a discount, the approaches disclosed herein are preferable.

Second, the disclosed techniques offer several tools that may be useful marketing devices for Merchants. For example, Merchants can drive targeted offers to specific Customers based on information about those Customers, including demographic, psychographic and spend based information. Such information may be obtained directly from the Customer, through integration with a third party platform such as a social network or from data provided through the Customer behavior. These offers may be in the form of increased incentives with the goal of motivating a specific behavior (e.g. driving a Customer into a location during a specific period, driving a return trip or “bounceback”, driving increased purchase frequency, driving larger basket sizes, etc.). As well, the offers need not be served to all Customers in the database; rather, this method may allow customization of the offer to each Customer based on their preferences and information, as provided above.

As an additional example of the marketing tools offered by the approaches disclosed herein, Merchants may drive purchase of specific products or product categories. Merchants may be interested in getting Customers to buy a specific product, or to shop with a specific category of the store, because that purchase has a specific value to the Merchant (e.g. trial of a new product, clearing out inventory or shelf space, higher margins, seasonal relevance, etc.).

According to some embodiments, the techniques disclosed herein may help Merchants and Causes to grow their email list or Consumer Relationship Management (CRM) databases. For example, the Platform may offer Customers the ability to opt-into receive emails from the Merchant or Cause, and then may share that email with the Merchant or Cause to add to their database.

In various embodiments, this method may use geography to enhance the relevance of Merchant marketing messages. For example, this method may use geotargeting, via a Customer's computer or mobile device location services, to identify the location of a Customer, and then serve that Customer relevant Merchant advertisements or information. As well, the method may allow users to identify participating Causes and Merchants on a map using their computer or mobile device, to help the Customer locate the Cause or Merchant.

In some embodiments, the techniques disclosed herein may provide data and analytics to Causes, Merchants and other parties based on Customer insights, spend behavior, self reported data and other behaviors. This data and analytics is provided with the Customer's consent, and in some cases is provided in aggregate to protect individual Customer's privacy.

The techniques described herein in various embodiments may include several advantages for various stakeholders including, for example, Customers, Merchants, Causes, Banks/Payments Networks, the Environment and our Communities:

Customers can use their normal and/or preferred methods of payment and get the benefits or perks associated with those methods; they do not have to be concerned with acquiring and carrying special cards or coupons, such as stored value cards or restricted access cards; they do not have to remember a unique URL and can accrue the benefit in brick-and-mortar locations as well as online; this also provides easier cash management for the Customer. Most importantly, Customers can raise money for their favorite cause while they shop or dine instead of going out of pocket or by having to purchase items they may not need (e.g. chocolate, wrapping paper, magazine subscriptions, scented pens, etc.).

Causes require fewer internal resources to fundraise through this method, saving them time and money; they raise more money because the transaction is simpler for the Customer so more customers are likely to participate, because all of the Customers' spend at participating Merchants is captured (whereas in scrip fundraising only the value tied to stored value cards is captured, while overspend is not), and because they benefit from Customer spend in brick-and-mortar environments, where over 90% of commerce takes place, as well as online; cash management is simplified compared to other methods; and they have to spend less time and energy targeting and bombarding Customers with fundraising requests, which is stressful and tiresome.

Merchants may be able to target specific Customers/Causes via this channel to incentivize them into the store; they can build loyalty and gain market share; there may be a significant amount of data available compared to other methods to help them better understand their Customers and their marketing spend; this does not degrade the brand value or train customers to only shop when they get a deal as do other promotional methods, including programs that involve cash back and discounts; this method can increase the emotional bond or loyalty of the Customer because it allows the Merchant to appeal to something specific that the Customer cares about (the Cause they are supporting through the Platform), instead of other methods where the Merchant donates to a limited set of Causes or Causes selected by the Merchant; the Cause donation may create goodwill for the brand in the marketplace; the ease of Customer participation may drive incremental transaction size and volume; there is no production and fulfillment costs for the Merchant as in other methods; the Merchant may have significant influence over their Donation value, thereby giving them the opportunity to ensure that their marketing efforts are profitable; there is less fraud potential than in prepaid/scrip; the Merchant may incur a tax benefit associated with their Donation or marketing expense; and this is great avenue to divert incoming donation requests, thereby saving them time and money on operations, while turning those donation requests into sales.

Banks/Payment Networks see increased share of wallet: when a Customer registers their payment device on the Platform they are more likely to use it when shopping (this effectively creates a loyalty program for the Banks/Networks); they get increased visibility through promotion by the Causes; and they build goodwill with their Customers and their communities by being involved in a give-back program.

Environment+Communities benefit when Customers use the Platform to raise money for environmental- or community-focused Causes, as those Causes can use the money raised through the Platform to benefit environmental, community, social, educational, health, and other positive initiatives. In addition, Customer's spend at Merchants in various communities provides income, tax revenue and jobs in those communities, which further benefits their economies.

### DETAILED DESCRIPTION

The fundraising through card-linked- and receipt-verified shopping techniques disclosed herein in various embodiments allow money to be raised for nonprofits, schools, and/or other organizations when merchants donate a portion of sales on each transaction made using credit, debit, and/or mobile payment devices that have been registered with the Platform, or verified through receipt submission by the Platform.

In one example, a Customer links or registers their credit card with the Platform, then uses the linked/registered card to make a purchase at a participating Merchant. The Merchant donates a portion of that sale to the Customer's preferred Cause based on the transaction details.

In another example, a Customer purchases a specific product from a Merchant, then submits a photo of their transaction receipt from that purchase to the Platform. The Merchant then donates a portion of the value of that item sale to the Customer's preferred cause based on the transaction details.

Platform: A Platform may include the firm that is orchestrating the relationship between the Merchant, the Cause, the Customer, and/or other entities, as well as its technology developed for orchestrating that relationship. This technology may include a website or mobile application. In various embodiments, the Platform may be an independent entity or one that is affiliated with a Merchant, bank, processor, payment network, other payment aggregator, nonprofit, government entity and/or other group. Customers may interact with the Platform through their mobile device, tablet, computer, phone or other method.

Merchant: A Merchant may include a retailer, restaurant, service provider, consumer packaged goods company (CPG), manufacturer, or vendor that funds a donation to a Cause each time a Customer makes a qualifying transaction. Qualified transactions are any sale or transaction which meets certain parameters pre-defined by the Merchant and Platform, and which may be identified by the Platform when the Customer uses a registered payment device (e.g. credit, debit, and/or mobile payment device) at a business or when the Customer submits a receipt for a transaction at a business. The business may include a physical, brick-and-mortar, permanent, temporary or online location.

Cause: A cause includes nonprofits, charities, schools, PTAs, sports teams, bands, school clubs, church groups, and anyone who may fundraise for a cause and/or the entity that is a recipient of donations from the Merchant (which may flow through the Platform).

Customer: A customer may include a consumer, end-user, supporter and/or other user who may use the Platform, transact with a Merchant or who may support a Cause. Customers may register a credit, debit, and/or mobile payment device with the Platform and then spends on that payment device at the Merchant. They may also submit transaction receipts to Platform. A Customer may select the Cause(s) to which they want a portion of that spend donated, and, in some embodiments, may be able to split the Donation across multiple Causes.

Donation: A Donation may include a value the Merchant agrees to contribute to the Cause. A Donation may include, for example, a percentage (%) of the value of each transaction on the Customers' registered cards. The Donation may flow through the Platform instead of going directly to the Cause, though that is not always the case.

The figures illustrated herein in various embodiments include representations of the mobile application experience of a Card Linked Offer Platform. Desktop, mobile web, and/or other versions may include similar features, but the design for those versions may be, for example, more consistent with a full desktop experience.

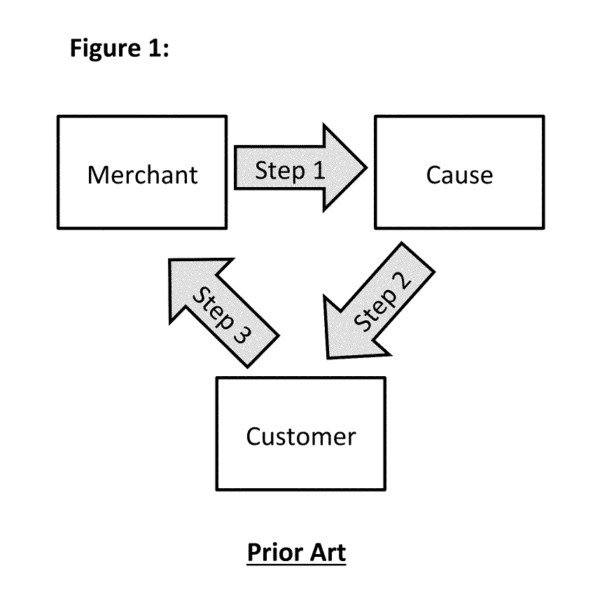

FIG. 1 presents an illustration of an existing method, which involves gift cards for fundraising. In step 1, the Merchant sells gift cards, at a discount, to a Cause. In step 2, the Cause then sells those gift cards for face value to Customers. The Cause keeps the difference as profit. In step 3, the Customer then redeems those gift cards at the Merchant location.

This approach may be inefficient because it creates a cash-crunch for the Cause and Customer, who may have to float the cash to buy the gift cards in advance of their redeeming transaction. In cases where the gift card goes unused, the Customer ends up with wasted value, and the Merchant usually cannot recognize revenue. And, it takes a significant amount of time for the Cause to administer because they have to solicit their supporters to find out how much each wants to spend at each of the participating Merchants, fund the purchase of the gift cards to those Merchants, then chase their supporters down to sell them the gift cards they requested and collect money.

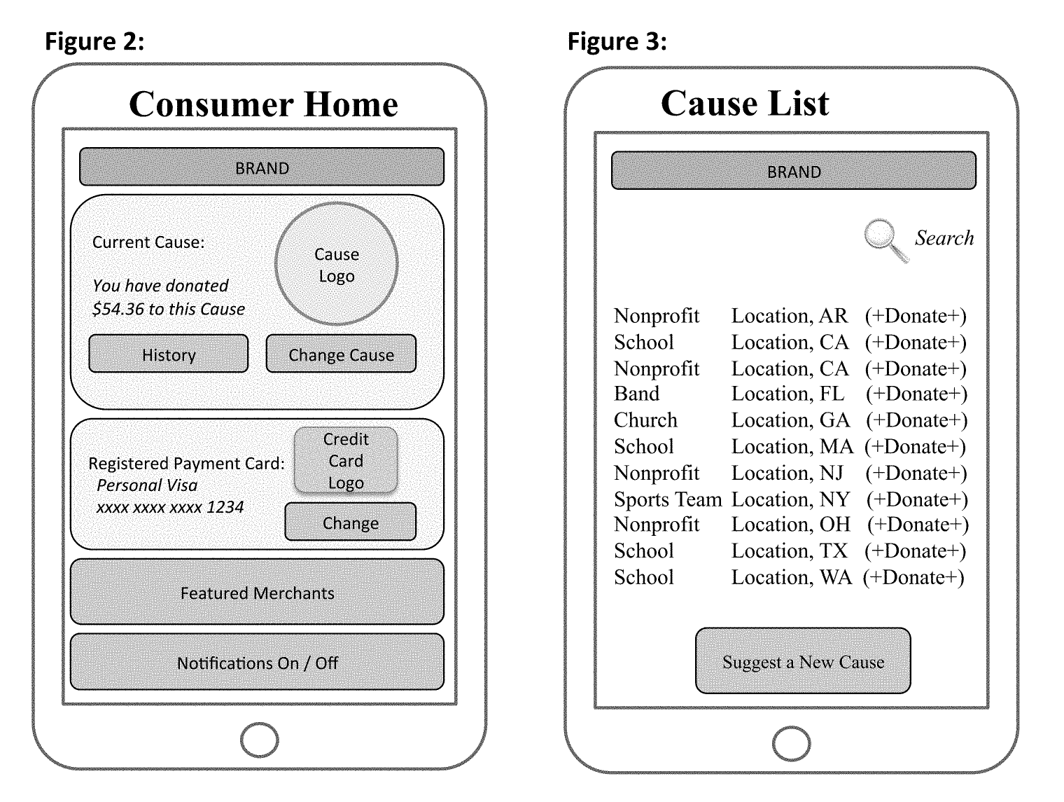

FIG. 2 shows a display (e.g. summary page) where a Customer can see and/or edit which Cause they are contributing to, how much they have raised on behalf of a Cause, and the payment device(s) (e.g. credit, debit, and/or mobile payment device) they have registered. This information is customizable, and may be presented in different formats or in separate settings screens or sub-menus. This particular example also shows examples of featured Merchants, which is an opportunity to promote specific Merchants by the Platform.

FIG. 3 illustrates a display showing a list of participating Causes to which the Customer can direct the Donations tied to his or her spend. This example also allows Customers to search for a specific Cause (by name, location, or type, for example), and suggest new Causes as well. It may also include categorization of Causes to make searching easier for the Customer. It may allow the Customer to opt-in to direct Donations to their preferred Cause from this screen, or may direct the Customer to do that in another location.

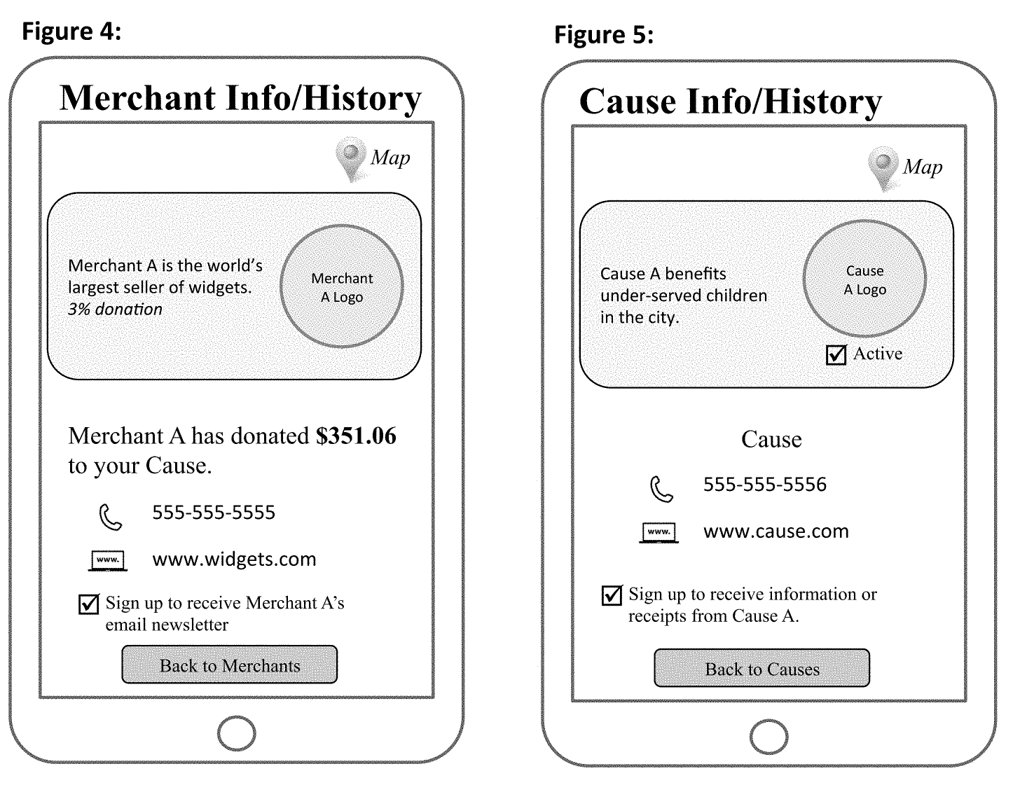

FIG. 4 shows a detail screen for one of the Merchants that participate on the Platform. This detail may include, for example, information about the Merchant (e.g. information about their category, business type, products, seasonal information, events, etc.), contact information for the Merchant, information on how much the Customer has spent at the Merchant or how much the Merchant has contributed to the Customer's preferred Cause via Donations and/or the ability to opt into communications from the Merchant. It may also include the ability to find Merchant's location on a map.

FIG. 5 shows a detail screen for one of the Causes that participate on the Platform. This detail may include, for example, information about the Cause, contact info for the Cause, information on how much the Customer has raised for the Cause, the ability to opt into communications from the Cause (e.g. emails from the Cause or notifications/receipts for Donations to the Cause) and/or information about how to get more involved with the Cause, such as through volunteering. It may also include the ability to find Cause's location on a map.

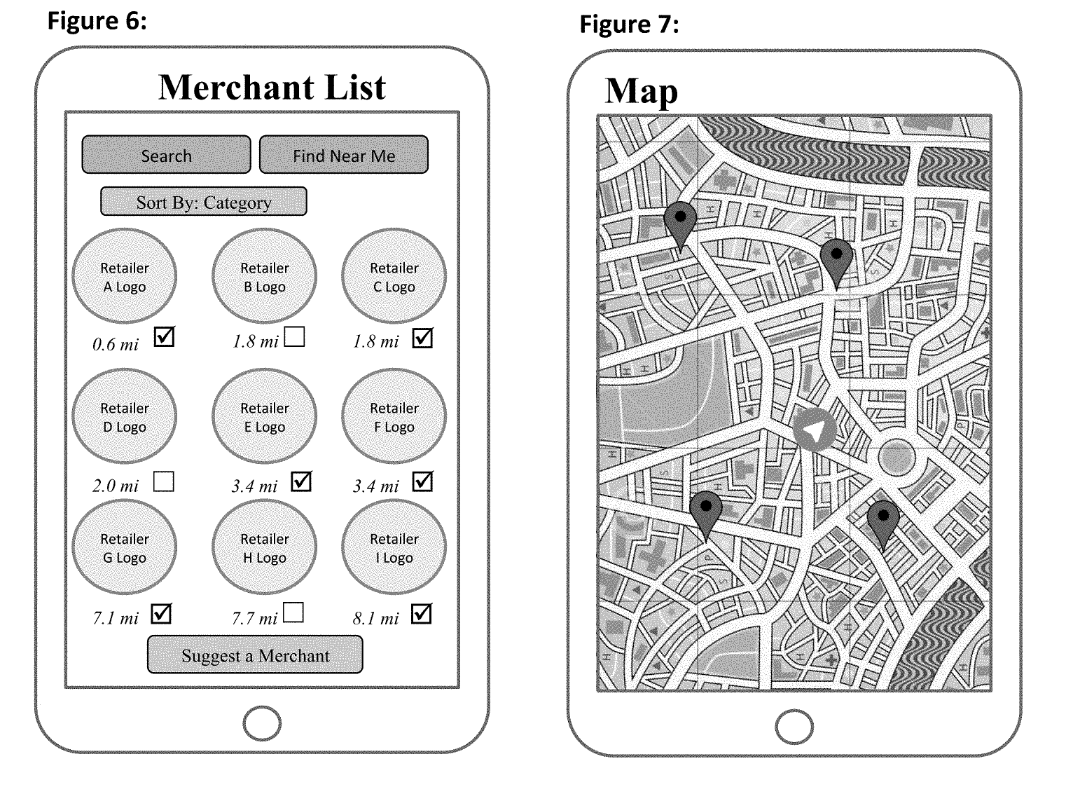

FIG. 6 illustrates a list of Merchants who participate in the program. For example, the Merchants shown may have signed up to donate a portion of registered Customer's transactions to the Customer's preferred Cause. In this example, the Customer can sort the list of Merchants in several ways (e.g. by geographic distance, merchant category, etc.). This example also allows Customers to search for a specific Merchant (by name, location, or type, for example), or locate Merchants on a Map. The Customer may also suggest new Merchants as well. The Customer may be required to opt into each Merchant from whom they want to benefit (though that feature may not be present in some embodiments). It may also include categorization of Merchants to make searching easier for the Customer.

FIG. 7 shows an example of a mapping feature whereby the Customer may locate Merchants or Causes in proximity to their own location. This map may be tied to native or downloaded mapping programs or applications on the Customer's device, including in the map rendering and Customer location, or may be a native feature within the Platform. In this example, the Customer's location is represented with an icon (in this case, a blue circle with an arrow), while merchant or Cause locations are represented with red pins. In some cases, if the Customer clicks on a pin it will bring up the corresponding Merchant or Cause landing page, as shown in FIGS. 4 and 5.

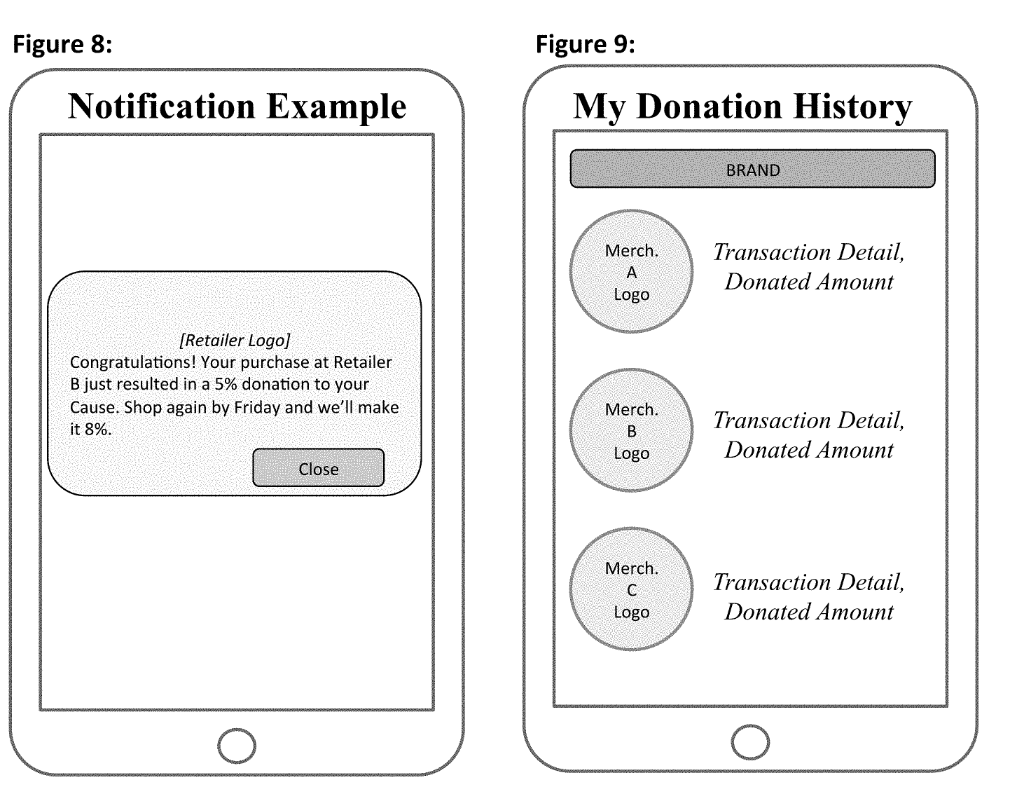

FIG. 8 shows an example of a notification that a Customer may receive upon transacting with a participating Merchant. This notification may also be presented as an email, SMS/MMS/text message, web-based, and/or other type of notification. The donation amount may be presented as a dollar figure or percentage. This displays one example of a marketing messaging from Merchants that may be included (in this case, the Merchant presents a “bounceback” offer to attract the Customer back to the store), but Merchants, Causes and Platforms may customize this message in any number of ways. This is one example of the marketing focus which is superior in this method compared to other fundraising methods.

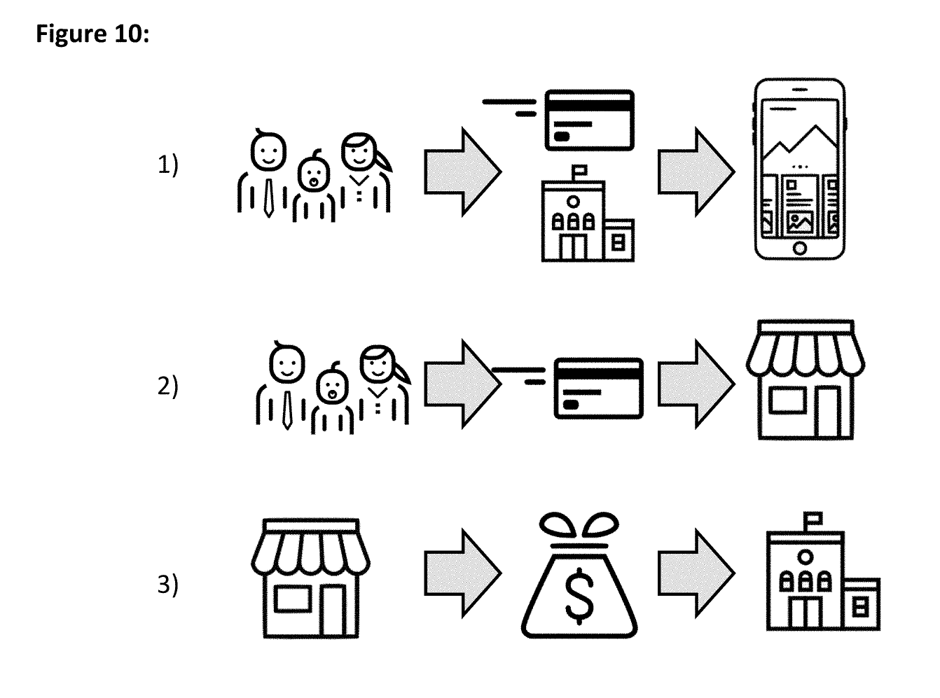

FIG. 9 illustrates a display (e.g. page) where a Customer can see and track the history of Donations tied to their spend at participating Merchants. For example, the Donations may be listed individually by transaction, or aggregated by Cause to which they have directed those funds. This page may include the Merchant name or logo to help the Customer identify the transaction, and/or also as a branding opportunity for the Merchant to get their brand in front of the Customer in a favorable way.

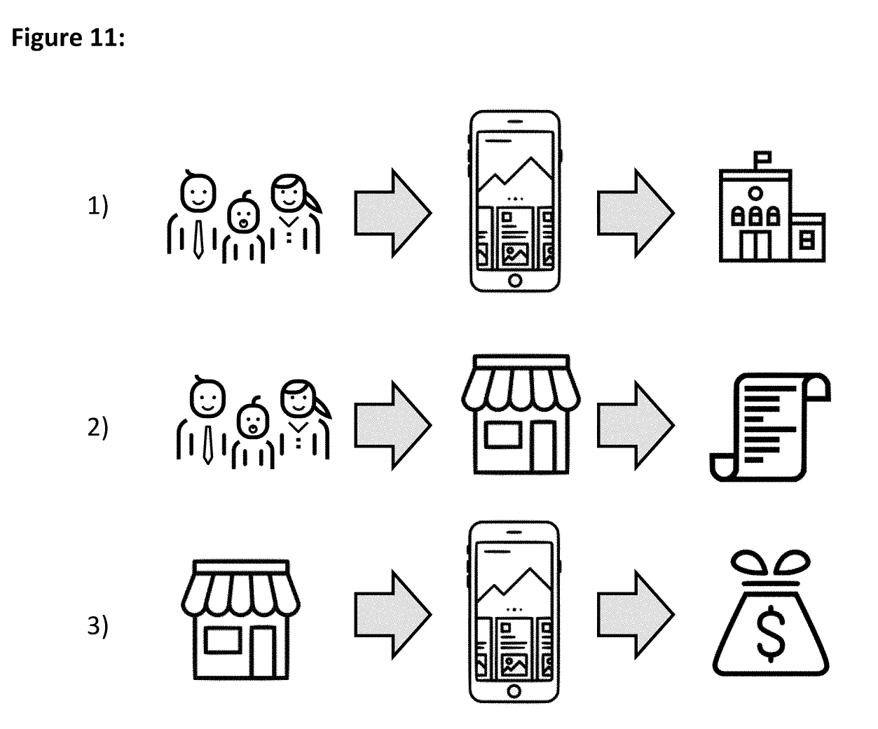

FIG. 10 describes one embodiment for fundraising through card-linked shopping. In step 1, the Customer registers with the Platform, and may be asked to link their preferred payment device (e.g. credit, debit card, mobile payments account, etc.) and their preferred Cause for which they want to raise money. In step 2, the Customer uses their linked payment device at a participating Merchant. The information from that purchase is passed to the Platform, along with a Customer identifier, either directly from the Customer in the form of a receipt, or from a source in the payment stream such as the point-of-sale, payment processor, payment network or bank. In step 3, the Platform facilitates a Donation that is a portion of that purchase to the Customer's specified Cause. As an example, the Platform may invoice the merchant for a portion of the transaction, the Merchant may pay the invoice amount to the Platform, and the Platform may redirects all or part of that contribution onto the Customer's selected Cause.

FIG. 11 describes one embodiment for fundraising through item-level or SKU-level purchases. In this embodiment, the Platform drives Cause Donations based on products the Customer purchases, rather than the full transaction value. In step 1, the Customer registers with the Platform and selects their preferred Cause, just as in step 1 of the previous figure. In step 2, the Customer makes a purchase at a participating Merchant. The Customer may be given a receipt at the end of the transaction, which they may send to the Platform, often through a mobile application, website, email, or other electronic method. The Platform then analyzes the details of that receipt to identify specific items, which are flagged for promotion by the Platform in partnership with the Merchant. In an alternative embodiment, the Platform may work with the Merchant to install software or to integrate with their Point of Sale system, such that the Merchant may feed this item level data in an automated way, rather than getting the info from the Customer's receipt, which is an extra step for the Customer. In step 3, the Platform facilitates a Donation that represents a portion of the value of the items within that purchase to the Customer's specified Cause. As an example, the Platform may invoice the merchant for a portion of the transaction, the Merchant may pay the invoice amount to the Platform, and the Platform may redirects all or part of that contribution onto the Customer's selected Cause.

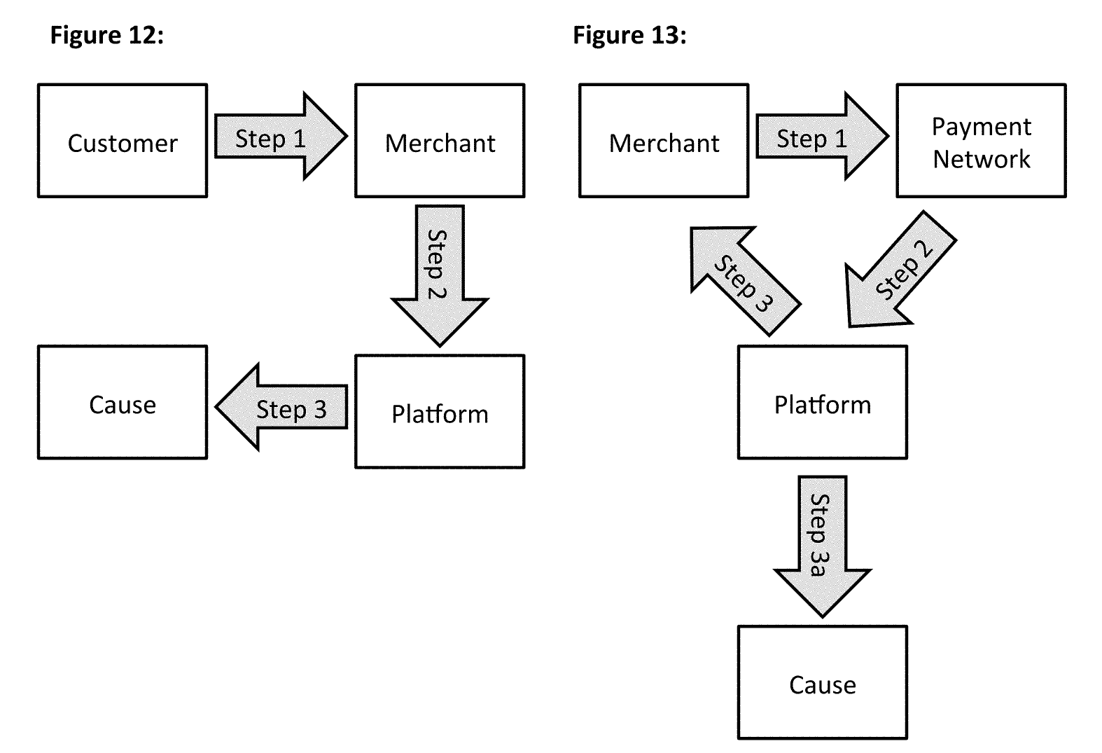

FIG. 12 is a flow chart describing an embodiment of the Platform payment flow (see Claims section for alternative embodiments). In Step 1, the Customer spends on their registered credit, debit and/or mobile payment device at Merchant, or submits a transaction receipt from a Merchant to the Platform. In Step 2, the Merchant pays the Platform for the Donation value plus an administrative fee. In Step 3, the Platform pays the Cause the Donation value, and in some embodiments, may withhold an administrative or transaction fee.

FIG. 13 describes an embodiment of the flow of data in the Platform process. In Step 1, transaction information flows from the Merchant to the payment network, bank, payment processor, and/or aggregator. Transaction information may include masked, unmasked or tokenized payment device information, location (e.g. business unit number, address, or merchant identification number), time stamp, lane or POS information, transaction value, and/or SKU-level/product information including product name, description, size, quantity and price. In some embodiments, the transaction information may flow directly from the Customer to the Platform instead of going through a payment network, for example when the Customer submits a transaction receipt to the Platform.

In Step 2, that transaction information flows from the payment network, bank, payment processor, and/or aggregator to the Platform. In various embodiments, the transaction info may be secured (e.g. encrypted) at the payment network, processor, bank and/or aggregator and provided to the Platform in a secure format. For example, the transaction info may be provided to the Platform using a secure method such as via tokenization.

In Step 3, the Platform may aggregate, analyze, and/or otherwise process the data. In some embodiments, the Platform may decrypt and/or otherwise process the data received from the payment network. For example, the decrypted data may be aggregated, analyzed, anonymized, organized, and/or processed for delivery to the Merchant, Cause, and/or other entities. In some embodiments, the Platform may provide a form of the data back to the Merchant using, for example, an approach that protects Personal Identifiable Information. In Step 3a, the Platform may aggregate spend or Donation data by Customer and share with the Merchant or Cause.

In various embodiments, the Card Linked Fundraising techniques disclosed herein may be performed as follows.

Causes and Merchants register with Platform via website, mobile, phone, and/or other communication context. Merchants may decide what value they want to Donate to each Customer's Cause. For example, some Merchants may choose to donate a percentage of each transaction at their locations through the Platform.

Cause, Platform, Merchant or payment entity may encourage Customers to register with Platform to participate. Customers may register with Platform via website, mobile application, phone, and/or other communications context.

The Customer may link their preferred payment device (e.g. credit, debit, and/or mobile payment method) via, for example, Platform website or mobile app. The Customer may be able to link multiple devices at once. In some embodiments, the Platform, Cause, Merchant or other entity may issue a Restricted Access Network card, issued in partnership with one of the payment networks and redeemable at select Merchants.

On the Platform, the Customer may see a list of participating Merchants and Causes, as well as information about each. Such information may be presented in a list, or on a dedicated landing page for each Merchant or Cause, and may include information about the Merchant or Cause, logo, contact information, description of contribution to Customer's Cause, or geographic information (which may be presented via a map).

The Customer may be able to select a preferred Cause (or Causes) which they want to benefit from their shopping and dining, using the Platform. In some scenarios, one Cause may have several “chapters” or subsets. In one example, a school may have several organizations within that it wants to support, such as band, sports teams, clubs, classrooms, etc. In another example, a national nonprofit organization may have local or regional chapters to which it would like to direct charitable donations. The Platform may display subsets or chapters of Causes, and/or allow the Customer to select a subset or chapter of a Cause to direct their Donations.

In one embodiment, the Platform may be integrated (e.g. directly and/or via a third party) with banks, payment processors, networks, other payment aggregators, and/or directly with the Merchant to be able to track spend data at specific Merchants in a secure method. The secure method may include, for example, tokenization, encryption, securing of Customer data, and/or requiring limited information, such as PAN (the card's Primary Account Number, usually a 16 digit number), and not CVV (Card Verification Value, usually a 3-4 digit number). In another embodiment, the Platform may not require integration with the Merchant or other parties to track Customer spend. Rather, the Platform may ask the Customer to upload a transaction receipt after the Customer shops or dines with participating Merchant.

The Customer shops or dines with a participating Merchant. The Customer may use their registered payment device at participating Merchants, or they may send the transaction receipt to the Platform after the transaction is complete.

The Platform tracks the transaction. In one embodiment, they do so through the integration described above, wherein the bank, payment processor, network, payment aggregator, or Merchant notifies the Platform when the Customer transacts at Merchant. In some cases, the notification may not specify any details of the Customer, but rather may include token information that the Platform then matches to the Customer's information.

In various embodiments, the Customer submits a transaction Receipt to the Platform, which the Platform then validates to confirm accuracy, authenticity, and whether it qualifies for an agreed-upon incentive. The Platform may use a human, computer or other machine to validate the details of the receipt, which may include date, time, amount, location, payment method, and/or details of items purchased. In this scenario, the Platform may prompt the Customer to upload their receipt. Such prompt may be driven by a specific trigger, such as the Customer's geography (geotargeting) or a notification from a payment network as tied to the Customer's payment device, as described in the above embodiment. In some embodiments, the Platform may take the step of verifying that the submitted receipt is valid, non-duplicate and real to prevent fraud or duplication.

The Platform may invoice the merchant for the Donation value tied to the transaction described above. In some cases, Platform will also charge an administrative fee to be kept by the Platform. The Merchant pays the Platform the value of the invoice. Such invoice may be sent at different periodic intervals as agreed to by Platform and Merchant, including after each transaction, or on a weekly, biweekly, monthly or other periodic basis. In another embodiment, the payment amount may not be paid through an invoice method, but rather by taking the Donation value and any other fees out of existing payment flows between the Merchant, bank, payment processor, marketing partners, or other entities. In yet another embodiment, the Merchant may pay a portion of the value directly to the Cause or to another entity, such as a related entity set up by Platform, rather than paying all of it to the Platform. In some cases the Cause may invoice the Merchant directly as well.

In scenarios where payment is not sent directly from Merchant to Cause, Platform issues a payment for the amount of the Donation to the Cause. Platform may charge a fee to Cause for participation in the Platform.

The Customer may receive a notification via mobile device or email (if opted in) to confirm the transaction and/or Donation.

Once registered with the Platform, Customers may be able to track their track their behavior and the funds raised through that behavior within the system's interface. This may include a summary of funds raised in total, for each Cause and by each merchant, and may be specific for each Customer and/or for the Platform as a whole. As one example, the Platform may show the Customer how much each Merchant has donated to their Cause or to all Causes. As another example, the Platform may show the Customer a total of funds the Customer has raised for their Cause, as well as a list of all transactions they have made on the Platform. Such a transaction list may include Merchant logos, Merchant Names, Cause Names, dates, transaction values, and/or donation values. This info may be used to help reinforce Merchant or Cause branding and establish a bond between Customer and Merchant or Cause. This list may also include a database of receipts submitted by Customer to Platform, which allows the Customer to see which receipts they've submitted, keep track of receipts, and refer to data from the receipts as needed.

Once registered with the Platform, Customers may receive messages from Platform, Causes or Merchants, the goal of which is usually to inform the Customer or provide some type of incentive to drive a behavior. All Customers on a Platform may receive these messages, or certain Customers may be selected to receive messages based on information about the Customers, including demographic, psychographic, geographic or spend based information and Customer-supplied preferences. Such information may be obtained directly from the Customer, through integration with a third party platform such as Facebook or from data provided through the Customer behavior.

In one embodiment, Merchants may contact Customer, often via the Platform, with targeted offers that may be relevant to Customer. Here are some examples of such offers.

An increased Donation percentage on the next shopping trip following a transaction. An increased Donation percentage during a specific time, such as “February”, “back-to-school”, “next week,” “by Thursday,” or “weekdays between 12 and 2 pm.” An increased Donation percentage on specific goods purchased, or specific categories of goods purchased. For example, a grocery store may run an incentive tied to all produce purchases. As another example, a Merchant or CPG may run an incentive tied to purchase of a specific brand. The intent of this would often be to drive a trial purchase of an item or item category, or to drive purchases of products that have a specific value to the Merchant (e.g. clearing out inventory or shelf space, higher margins, seasonal relevance, etc.). An increased or accelerated Donation value on transaction sizes over a certain value. An incentive tied to a volume of purchases, such as “after you make 3 transactions” or “after you make 2 transactions this month.” Additional points on a Merchant or Platform points or loyalty program.

In another embodiment, Platform may contact Customers to inform them about the Platform, new enhancements, partners (e.g. Causes or Merchants), incentives, transactions or Donations, or other information that might be useful to Customers.

In some embodiments, Cause may contact Customers about their Donations, provide them with tax receipts, or other information about the Cause that may be relevant to the Customers. This method may provide tools to Causes to help increase Customer engagement and funds raised through the Platform, and to Merchants to help drive loyalty or increased spend with the merchant.

In one embodiment, the method may include some form of “gamification,” whereby Customers are encouraged to compete with one another on the Platform for points, status, or other benefits.

In another embodiment, the Platform may establish “tiers” or “badges” to classify Customers based on achievement of specific milestones within the Platform, similar to that found in common travel loyalty programs.

In another embodiment, the Platform may establish one or many “leaderboards” to compare the relative activity of each Customer. Such leaderboards could be created by Cause, by geography, by community, across the entire Platform, or based on any other segmentation.

In another embodiment, the Platform may include tools to engage the Customer in activities outside of the Platform, such as to encourage the Customer to volunteer with the Cause or attend events at the Merchant.

This method may help Merchants and Causes to grow their email list or Customer Relationship Management (CRM) databases. For example, the Platform may offer Customer's the ability to opt-into receive emails from the Merchant or Cause, and then may share that email with the Merchant or Cause to add to their database.

This method may use geography to enhance the relevance of Merchant marketing messages. In one such embodiment, this method may use geotargeting, via a Customer's computer or mobile device location services, to identify the location of a Customer, and then serve that Customer relevant Merchant advertisements or information based on that location. In another embodiment, the method may allow users to identify participating Causes and Merchants on a map using their computer or mobile device, to help the Customer locate the Cause or Merchant, which may make it easier for Customer to interact with Cause or Merchant.

This method may also have the ability to gather information on Customers, Causes and Merchants, and to be able to utilize that information to enhance its own Platform or to sell to and/or share with partners (including Causes and/or Merchants), if valuable to them. This information may be based on Customer, Cause or Merchant behavior, such as spend behavior, geography, demographics and/or psychographics, and may be collected through the Platform, directly by the Customer or from third party data sources, such as Facebook. In some cases, this information may be aggregated prior to sharing with external parties in order to protect individual Customers' privacy, and in many cases this information is provided with the Customers' consent.

Some examples of this information may include transaction information, transaction volume, transaction frequency, transaction size, share of wallet, items purchased (including descriptions, sizes, prices, quantities, etc.), transaction time or date, location information, donation information, incrementality, and/or patterns between all of the above.

In one embodiment, this information may be shared directly with Merchants, Causes, or other partners by the Platform. This information may be customized by Platform to suit the receiving party's needs.

In other embodiment, this information may be available in a “pull” format, whereby Merchants, Causes and other partners can pull this information out of a portal or tool created by the Platform. The information may be customizable by the receiving party based on their needs.

Platform may include forms that Causes, Merchants or Customers can learn about the Platform and apply to participate in the Platform. Such forms may be as basic as allowing them to submit an inquiry, or as robust as allowing them to complete the sign up process and all information required to get them on the Platform. For example, a Merchant intake form might include fields to request information about the merchant, contact information, preferred text for the Merchant's landing page, and/or ability to upload a logo.

Platform may provide an incentive system for Causes, Customers or Merchants to help grow the Platform. For example, it may offer an incentive to Causes, Customers or Merchants who sign up new Causes, Customers or Merchants to the Platform. As another example, Platform may offer an incentive to Causes, Customers or Merchants who promote the Platform via email, social network, word of mouth or other methods. Platform may also include tools that allow Causes, Merchants and Customers to update or edit their public-facing profile, including images, text, contact information and more.

What is claimed is:

1. A computer-implemented method, comprising:
receiving, at a fundraising platform, purchase information and a customer identifier, the purchase information associated with a transaction between a merchant and a customer associated with the customer identifier;
determining a cause associated with the customer identifier, wherein the customer identifier was previously registered with the cause at the platform;
determining a donation based at least in part on the purchase information; and
facilitating, at the fundraising platform, payment of the donation to the cause.

2. The method of claim 1, wherein the purchase information is received at the platform from a mobile or web-based device application associated with the platform.

3. The method of claim 1, wherein the purchase information includes one or more of an amount spent by the customer at the merchant, items purchased by the customer from the merchant, services purchased by the customer from the merchant, and details of the purchase including one or more of date, time, location, payment method, and register number.

4. The method of claim 1, wherein the cause is registered with the platform.

5. The method of claim 1, wherein the merchant is registered with the platform.

6. The method of claim 5, wherein the purchase information is received directly from the merchant.

7. The method of claim 1, wherein determining the donation comprises:
determining one or more transactions, items or services included in the purchase information that are flagged for promotion;
determining purchase amounts associated with the each of the flagged transactions, items or services;
determining other information associated with the each of the flagged transactions, items or services, the other information including one or more of a date, a quantity, and a frequency; and
generating the donation based at least in part on one or more of the purchase amounts and other transaction information.

8. The method of claim 7, wherein the donation comprises a pre-defined portion of the purchase amounts.

9. The method of claim 7, wherein the donation comprises a pre-defined value set by merchant and platform.

10. The method of claim 1, wherein the purchase information is received from one or more of a payment network, processor and bank associated with the transaction between the customer and the merchant.

11. The method of claim 10, wherein the purchase information is secured at one or more of the payment network, processor, bank and the merchant.

12. A system, comprising:
a processor associated with fundraising platform; and
a memory coupled with the processor, wherein the memory is configured to provide the processor with instructions which when executed cause the processor to:
receive, at the fundraising platform, purchase information and a customer identifier, the purchase information associated with a transaction between a merchant and a customer associated with the customer identifier;
determine a cause associated with the customer identifier, wherein the customer identifier was previously registered with the cause at the platform;
determine a donation based at least in part on the purchase information; and
facilitate, at the fundraising platform, payment of the donation to the cause.

13. A computer storage medium having computer executable instructions which when executed by a computer cause the computer to perform operations comprising:
receiving, at a fundraising platform, purchase information and a customer identifier, the purchase information associated with a transaction between a merchant and a customer associated with the customer identifier;
determining a cause associated with the customer identifier, wherein the customer identifier was previously registered with the cause at the platform;
determining a donation based at least in part on the purchase information; and
facilitating, at the fundraising platform, payment of the donation to the cause.
